(19) United States
(12) Patent Application Publication
(10) Pub. No.: US 2011/0038273 A1
(43) Pub. Date: Feb. 17, 2011

(54) METHOD FOR DETECTING CONTINUOUS CHANNEL NOISE AND APPARATUS FOR USING THE SAME

(75) Inventors: MING TA LI, Hsinchu County (TW); SHEN PO LIN, Hsinchu County (TW)

Correspondence Address: HAMRE, SCHUMANN, MUELLER & LARSON, P.C., P.O. BOX 2902, MINNEAPOLIS, MN, 55402-0902, US

(73) Assignee: RALINK TECHNOLOGY CORPORATION, HSINCHU COUNTY (TW)

(21) Appl. No.: 12/854,296

(22) Filed: Aug. 11, 2010

(30) Foreign Application Priority Data
Aug. 14, 2009 (TW) 098127349

(51) Int. Cl. H04L 12/26

(52) U.S. Cl. 370/252

(57) ABSTRACT

The method for detecting continuous channel noise comprises the steps of: setting a threshold value of channel busy time and a threshold number of channel busy condition; setting a count value to an initial value; obtaining a measured value of the channel busy time during a beacon interval; determining whether the measured value of the channel busy time is larger than or equal to the threshold value of the channel busy time; if yes, the count value is increased by 1, and if not, the count value is reset to the initial value; and determining whether the count value is larger than or to equal to the threshold number of the channel busy condition; if yes, a noise disturbance alarm is generated, and if not, next channel busy time is obtained during a next beacon interval so as to determine whether the count value is increased or not.

### BACKGROUND OF THE INVENTION

1. Field of the Invention

The present invention relates to a method for detecting continuous channel noise and an apparatus for using the same, and more particularly, to a method for detecting continuous channel noise and an apparatus for using the same operating in accordance with the IEEE 802.11 standard.

2. Description of the Related Art

In accordance with the Institute of Electrical and Electronics Engineers (IEEE) 802.11n standard, a Distributed Coordination Function (DCF) based on Carrier Sense Multiple Access with Collision Avoidance (CSMA/CA) has been developed for building wireless local area networks (WLAN). The CSMA/CA protocol is designed to reduce the collision probability when multiple stations share a single channel to perform data transmission. FIG. 1 uses an example to illustrate a scenario in which a station attempts access on a channel using the DCF mechanism. Before transmitting a frame, the station determines whether the channel is idle or not by checking a value of a Received Signal Strength Indication (RSSI) of the channel. When the station detects that the channel is idle and preparing to transmit the frame, it starts waiting for a predetermined duration of idle time, referred to as the DCF Inter-Frame Space (DIFS). FIG. 1 also marks out Short Inter-Frame Space (SIFS) and Point Coordination Function (PCF) Inter-Frame Space (PIFS), wherein the SIFS and PIFS are used to provide higher priority to response frames. Upon completion of the DIFS interval, the station performs a backoff operation to obtain a channel access right while the channel is still idle.

If the channel is idle during every slot time, the station decreases a random backoff count value by a random backoff counter. When the count value is equal to zero, the station transmits the frame. Referring to FIG. 1, each station maintains a contention window (CW) which uses the random backoff count value. The random backoff count value is a pseudo random integer selected with an even probability in a range of [0, CW], wherein CW is initialized to a value CWₘᵢₙ and increased gradually whenever the frame transmission fails. The maximum value of CW is CWₘₐₓ and is returned to the initial value CWₘᵢₙ after the end of the frame transmission. In accordance with the frame interval with different priority and backoff operation mechanism, multiple stations can share a single channel and avoid possible access conflict.

However, when continuous noise disturbance occurs in the channel and its energy strength reaches a threshold value, such continuous noise may trigger circuits at a reception terminal and may be regarded as an effective packet. In addition, wireless transceivers in a wireless communication network usually operate in a half duplex mode, that is, a mode in which data cannot be transmitted and received at a same time. Therefore, the continuous noise will disturb normal packet transmission. Based on the above, it is necessary to provide a method for detecting continuous channel noise and an apparatus using the same to identify such continuous noise disturbance.

### SUMMARY OF THE INVENTION

The present invention proposes a method for detecting continuous channel noise and an apparatus for using the same.

The method for detecting continuous channel noise in accordance with one embodiment of the present invention comprises the steps of: setting a threshold value of channel busy time and a threshold number of channel busy condition; setting a count value to an initial value; obtaining a measured value of the channel busy time during a beacon interval; determining whether the measured value of the channel busy time is larger than or equal to the threshold value of the channel busy time; if yes, the count value is increased by 1, and if not, the count value is reset to the initial value; and determining whether the count value is larger than or equal to the threshold number of channel busy condition; if yes, a noise disturbance alarm is generated, and if not, next channel busy time is obtained during a next beacon interval so as to determine whether the count value is increased or not.

The apparatus for detecting continuous channel noise in accordance with one embodiment of the present invention comprises a calculation unit and a judgment unit. The calculation unit is configured to generate a maximum value of channel busy time according to a predetermined parameter table and the judgment unit is configured to receive the maximum value of the channel busy time and a measured value of the channel busy time for generating a noise disturbance alarm.

### BRIEF DESCRIPTION OF THE DRAWINGS

The invention will be described according to the appended drawings in which:

FIG. 1 uses an example to illustrate a scenario in which a station attempts to gain access on a channel using the DCF mechanism;

FIG. 2 shows four access categories with various predetermined parameter values;

FIG. 3 shows the table of MAC parameter values;

FIG. 4 shows a flow chart of a method for detecting continuous channel noise in accordance with an exemplary embodiment;

FIG. 5 shows a block diagram of a continuous channel noise detecting apparatus in accordance with one embodiment of the present invention; and

FIG. 6 shows a block diagram of a judgment unit in accordance with one embodiment of the present invention.

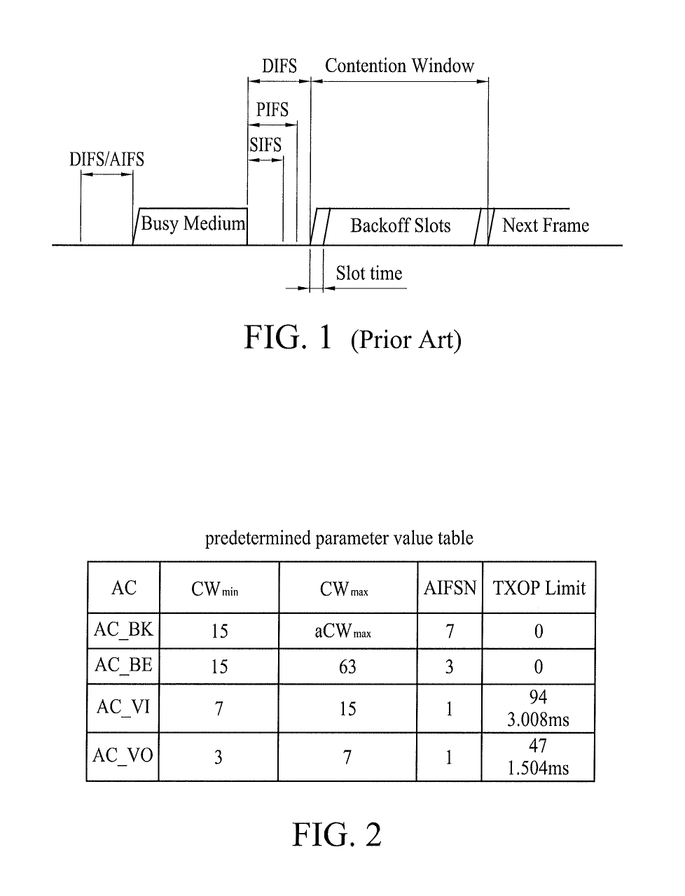

### PREFERRED EMBODIMENT OF THE PRESENT INVENTION

Because wireless bandwidth availability is restricted, Quality of Service (QoS) management is increasingly important in 802.11 networks. IEEE 802.11e proposes to define QoS mechanisms for wireless apparatuses that give support to bandwidth-sensitive applications including voice and video. The IEEE 802.11e standard defines four access categories: AC_BK (background), AC_BE (best effort), AC_VI (video), and AC_VO (voice). As shown in FIG. 2, the four access categories have various predetermined parameter values. The IEEE 802.11e standard uses these parameter values, such as a minimum contention window (CWₘᵢₙ), a maximum contention window (CWₘₐₓ), Arbitration Inter-Frame Space (AIFS), and Transmission Opportunity Limit (TXOP Limit) to secure QoS in the WLAN.

To identify continuous noise disturbance, it is necessary to obtain a maximum value of channel busy time. If a user sets the access category to the AC_VI (video), the user has a relatively lower probability than the AC_VO (voice) to obtain a channel access right. Therefore, the access category is first set to AC_VI (video) for calculating the maximum value of the channel busy time. Subsequently, according to the parameter values in FIG. 2, substitute chosen values for TXOP Limit=3.008 ms, AIFSN (a parameter to calculate AIFS)=1, CWₘᵢₙ=7, and CWₘₐₓ=15 in Equation 1 to obtain a value of backoff time.

AIFS[AC]+[0,CW[AC]]×aSlotTime=(AIFSN[AC]×aSlotTime+aSIFSTime)+[0,CW[AC]]×aSlotTime (1)

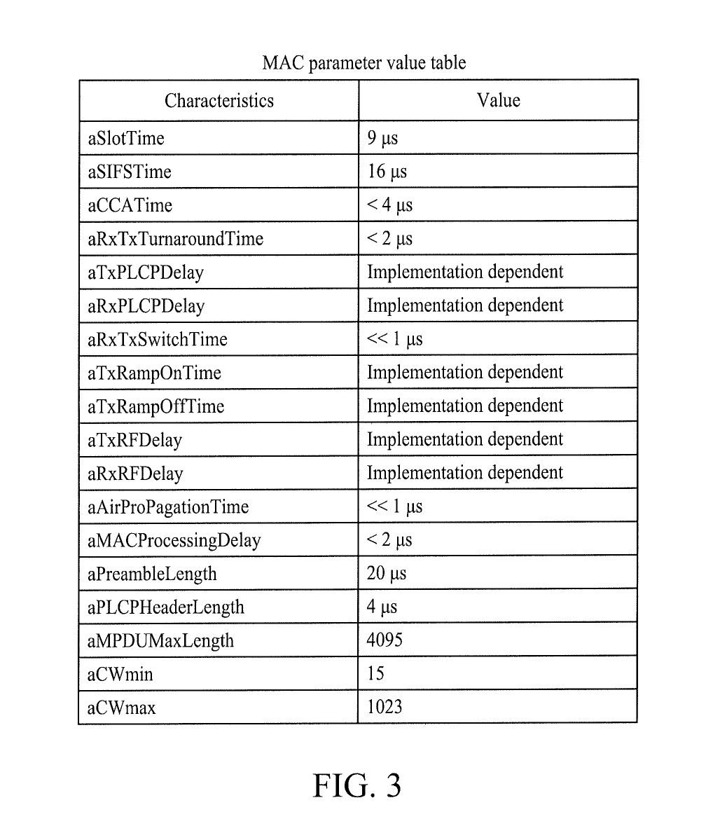

According to the table of MAC parameter values in FIG. 3, substitute chosen values for aSlotTime=9 μs, aSIFSTime=16 μs, and average value of CW=4 in Equation (1), and thus the value of backoff time=61 μs is obtained. Subsequently, the maximum value of channel busy time can be obtained according to the following equation:

$$\frac{T X O P Limit}{T X O P Limit + backoff\_time} \times beacon\_interval \qquad ( 2 )$$

Substitute chosen values for TXOP Limit=3008 μs, backoff_time=61 μs, and a predetermined beacon value beacon_interval=100 ms in Equation (2), the maximum value of channel busy time=98.01 μs is obtained. After obtaining the maximum value, an exemplary embodiment is introduced to describe a method for detecting continuous channel noise.

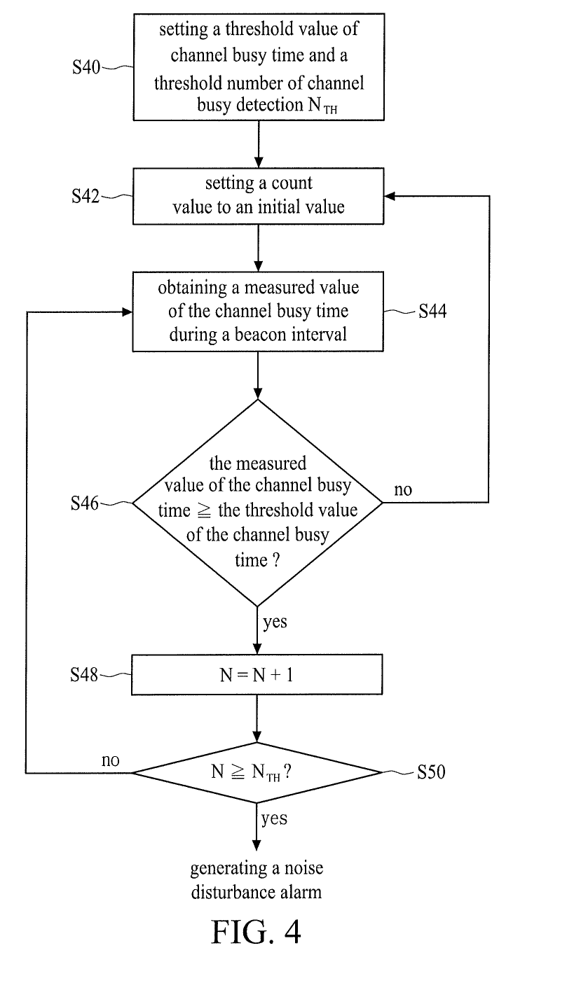

FIG. 4 shows a flow chart of a method for detecting continuous channel noise in accordance with an exemplary embodiment. In step S40, a threshold value of channel busy time and a threshold number of channel busy condition N_{TH} are set. In step S42, a count value N is set to an initial value. In step S44, a measured value of the channel busy time is obtained during a beacon interval. In step S46, when the measured value of the channel busy time is larger than or equal to the threshold value of the channel busy time, the count value N is increased by 1 in step S48; otherwise, the count value is reset to the initial value and the flow advanced to step S44. In step S50, when the count value N is less than the threshold number of the channel busy condition N_{TH}, the flow returns to step S44; when the count value N is larger than or equal to the threshold number of the channel busy condition N_{TH}, a noise disturbance alarm is generated. Hereinafter, the detailed detecting continuous channel noise method in accordance with embodiments of the present invention is introduced.

First, a maximum value of channel busy time is calculated from equations (1) and (2). For example, the maximum value=98.01 ms is obtained in the aforementioned example. Therefore, the threshold value of channel busy time is set to 99 ms. Meanwhile, a threshold number of channel busy condition N_{TH} is set to an integral larger than 1, i.e., 5. Next, a count value N is initially set to zero. Next, after obtaining a measured value of the channel busy time from a channel access controller supporting a channel busy time detecting function at every beacon interval (the predetermined value is 100 ms), the measured value of the channel busy time and the threshold value of the channel busy time are compared. If the measured value is greater than the threshold value, the count value is increased by 1; otherwise, the count value is reset to zero. If the measured value of channel busy time is larger than the threshold value of channel busy time at every beacon interval for five successive times, that is, the count value N≧5, a noise disturbance alarm is generated so that a wireless access point of the station is selectively switched to another channel or another bandwidth to proceed to transmit the frame.

In order to enable persons skilled in the art to practice the present invention in accordance with an exemplary embodiment, an exemplary embodiment of an apparatus for detecting continuous channel noise is provided in accordance with the aforementioned apparatus and method for detecting continuous channel noise.

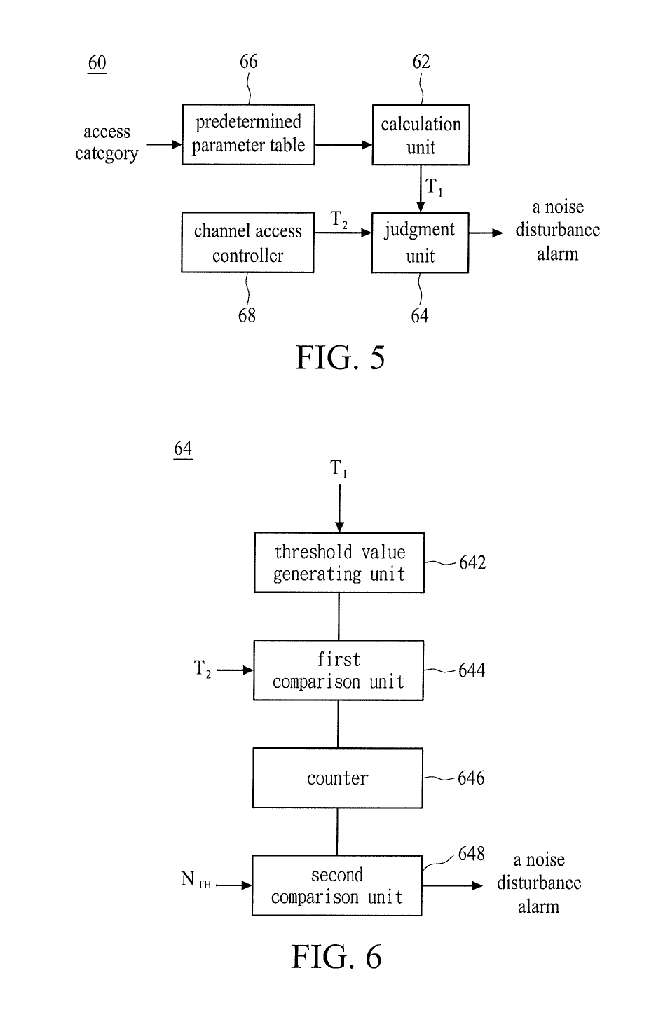

FIG. 5 shows a block diagram of a continuous channel noise detecting apparatus 60 in accordance with one embodiment of the present invention. The apparatus 60 comprises a calculation unit 62 and a judgment unit 64. The calculation unit 62 is configured to generate a maximum value of channel busy time T₁ according to a predetermined parameter table 66. The judgment unit 64 is configured to receive the maximum value of the channel busy time T₁ and a measured value of the channel busy time T₂ from a channel access controller 68 for generating a noise disturbance alarm. The channel access controller 68 supports a channel busy time detecting function.

According to one exemplary embodiment of the present invention, the predetermined parameter table 66 includes parameters CWₘᵢₙ, CWₘₐₓ, AIFS, and TXOP Limit as shown in FIG. 2. The parameters have different values according to the access categories. A parameter value in the predetermined parameter table 66 corresponding to an access category with the lowest probability of obtaining a channel access right is selected to obtain a backoff time. Subsequently, the backoff time is substituted into equation (2) to calculate the maximum value of the channel busy time T₁.

FIG. 6 shows a block diagram of a judgment unit 64 in accordance with one embodiment of the present invention. The judgment unit 64 comprises a threshold value generating unit 642, first and second comparison units 644, 648, and a counter 646. Referring to FIG. 6, after receiving the maximum value of the channel busy time T₁, the threshold value generating unit 642 generates a threshold value of the channel busy time. The first comparison unit 644 compares the threshold value of the channel busy time with the measured value of channel busy time T₂ from the channel access controller 68 at every beacon interval, and outputs the result to the counter 646, wherein the default value of the counter 646 is zero. When T₂ is larger than or equal to the threshold value of the channel busy time, the count value of the counter 646 is increased by 1; otherwise, the count value of the counter 646 is reset to zero. The count value of the counter 646 outputs to the second comparison unit 648 to compare with a threshold number of channel busy condition N_{TH}. When the count value of the counter 646 is larger than the threshold number of the channel busy condition N_{TH}, the continuous channel noise detecting apparatus 60 outputs a noise disturbance alarm to represent that the noise detected on the channel is continuous and the energy strength is strong enough to disturb frame transmission. Therefore, upon detection of the continuous noise, the wireless access point is selectively switched to another channel or another bandwidth to proceed to transmit the frame.

The above-described embodiments of the present invention are intended to be illustrative only. Numerous alternative embodiments may be devised by persons skilled in the art without departing from the scope of the following claims.

What is claimed is:

1. A method for detecting continuous channel noise, comprising the steps of:
setting a threshold value of channel busy time and a threshold number of channel busy condition;
setting a count value to an initial value;
obtaining a measured value of the channel busy time during a beacon interval;
determining whether the measured value of the channel busy time is to larger than or equal to the threshold value of the channel busy time; if yes, the count value is increased by 1, and if not, the count value is reset to the initial value; and
determining whether the count value is larger than or equal to the threshold number of the channel busy condition; if yes, a noise disturbance alarm is generated, and if not, the next channel busy time is obtained during a next beacon interval so as to determine whether the count value is to be increased or not.

2. The method of claim 1, wherein the measured value of the channel busy time is obtained from a channel access controller supporting a channel busy time detecting function.

3. The method of claim 1, further comprising a step of generating a maximum value of the channel busy time so as to set the threshold value of the channel busy time.

4. The method of claim 3, wherein the maximum value of the channel busy time is determined according to an access category with the lowest probability of obtaining a channel access right.

5. The method of claim 4, wherein the maximum value of the channel busy time is determined according to a ratio of Transmission Opportunity Limit to a sum of the Transmission Opportunity Limit and backoff time, and the access category determines values of the Transmission Opportunity Limit and the backoff time.

6. An apparatus for detecting continuous channel noise, comprising:
a calculation unit configured to generate a maximum value of channel busy time according to a predetermined parameter table; and
a judgment unit configured to receive the maximum value of the channel busy time and a measured value of the channel busy time for generating a noise disturbance alarm.

7. The apparatus of claim 6, wherein the measured value of the channel busy time is obtained from a channel access controller supporting a channel busy time detecting function.

8. The apparatus of claim 6, wherein the predetermined parameter table comprises parameters including a minimum contention window, a maximum contention window, Arbitration Inter-Frame Space, and Transmission Opportunity Limit, and backoff time is obtained according to the parameters.

9. The apparatus of claim 8, wherein the parameters have different values according to an access category and the maximum value of the channel busy time is obtained according to the access category with the lowest probability of obtaining a channel access right.

10. The apparatus of claim 9, wherein the maximum value of the channel busy time is determined according to a ratio of Transmission Opportunity Limit to a sum of the Transmission Opportunity Limit and backoff time.

11. The apparatus of claim 6, further comprising:
a threshold value generating unit configured to receive the maximum value of the channel busy time for generating a threshold value of the channel busy time;
a first comparison unit configured to compare the threshold value of the channel busy time with the measured value of the channel busy time at every beacon interval;
a counter configured to receive an output of the first comparison unit for generating a count value; and
a second comparison unit configured to compare the count value with a threshold number of channel busy condition;
wherein when the count value is larger than the threshold number of the channel busy condition, the second comparison unit outputs a noise disturbance alarm.

12. The apparatus of claim 11, wherein the counter has an initial value, and when the measured value of the channel busy time is larger than or equal to the threshold value of the channel busy time, the count value of the counter is increased by 1.

13. The apparatus of claim 12, wherein when the measured value of channel busy time is less than the threshold value of the channel busy time, the count value of the counter is reset to the initial value.
